(19) United States
(12) Patent Application Publication
(10) Pub. No.: US 2004/0205730 A1
(43) Pub. Date: Oct. 14, 2004

(54) System and method for building libraries and groups of computer programs

(76) Inventor: Jon J. Week, Northglenn, CO (US)

Correspondence Address: David B. Ritchie, Thelen Reid & Priest LLP, P.O. Box 640640, San Jose, CA, 95164, US

(21) Appl. No.: 09/879,440

(22) Filed: Jun. 11, 2001

(51) Int. Cl. G06F 9/44

(52) U.S. Cl. 717/136; 717/107

(57) ABSTRACT

A method and system builds a group of computer programs selected from at least one group of computer programs on a selected computer of a plurality of computers. Each group of computer programs has a set of specific environmental requirements in which the group of computer programs is to be compiled and executed, and each of the plurality of computers has at least one environmental characteristic. The method and system include displaying a list of at least one group of computer programs so as to allow a user to select a group to be built, displaying a list of a plurality of computers, receiving a user's selection of a group of computer programs, determining each computer capable of building the selected group of programs based on the at least one environmental characteristic, indicating the capable computers, and designating a capable computer in response to the user's selection of a computer.

### FIELD OF THE INVENTION

The present invention relates to the field of developing computer programs. More particularly, the present invention relates to a method and system for building a group of computer programs. COMPUTER PROGRAMS

### BACKGROUND OF THE INVENTION

Under a computer software development environment, a developer may create various types of computer programs, such as an executable, a routine, a module, a Fortran application, a complex application, and a user makefile application, etc. Such computer programs may be a set of programs or routines to be linked and combined into a larger program or application. A computer program to be built, which is referred to as a target program, depends upon various environmental factors, such as the type and version of the operating system and the CPU architecture of a target computer on which the program will be run or executed.

A typical software development system includes a plurality of computers (build machines, servers, hosts, and the like) which are networked into a computer system. Such a software development system may have a “make” utility to compile a program made up of several independent software modules. For example, using such a make utility, subprograms, files and/or libraries are compiled and linked together to create an application. Different parts of an application may be built concurrently in the development system by distributing build processes over several computers or build machines.

Since each build machine may have a different configuration, different operating system, or different software installed thereon, the software developer must select an appropriate machine which is capable of building the desired program or programs.

When a developer builds a program using such a software development system, the developer typically logs on to each build machine/computer through a host computer on the network so as to determine which machine(s) may be used for building the target program. However, it is quite time consuming and error prone to manually log on to each build machine and record its environmental statistics before attempting to build a target program on that build machine. Accordingly, it would be desirable to automate the process and to speed the process of developing software and thereby reduce the errors experienced in such efforts.

### BRIEF DESCRIPTION OF THE INVENTION

A method and system builds a group of computer programs selected from at least one group of computer programs on a selected computer of a plurality of computers. Each group of computer programs has a set of specific environmental requirements in which the group of computer programs is to be compiled and executed, and each of the plurality of computers has at least one environmental characteristic. The method and system include displaying a list of at least one group of computer programs so as to allow a user to select a group to be built, displaying a list of a plurality of computers, receiving a user's selection of a group of computer programs from the at least one group, determining each computer capable of building the selected group of programs based on the at least one environmental characteristic, indicating the capable computers, and designating a capable computer in response to the user's selection of a computer from the list of computers.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a tool for building a selected group of computer programs on a selected computer of a computer software developing system, in accordance with an embodiment of the present invention.

FIG. 2 is a block diagram schematically illustrating the tool for building a selected group of computer programs on a selected computer in accordance with an embodiment of the present invention.

FIGS. 3-5 are diagrams illustrating an example of a graphical user interface (GUI) representation of a software tool for assistance in building a selected group of computer programs in accordance with an embodiment of the present invention.

FIG. 6 is a process flow diagram schematically illustrating a method for building a selected group of computer programs on a selected computer in accordance with an embodiment of the present invention.

### DETAILED DESCRIPTION

Embodiments of the present invention are described herein in the context of a system and method for building libraries and groups of computer programs. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines.

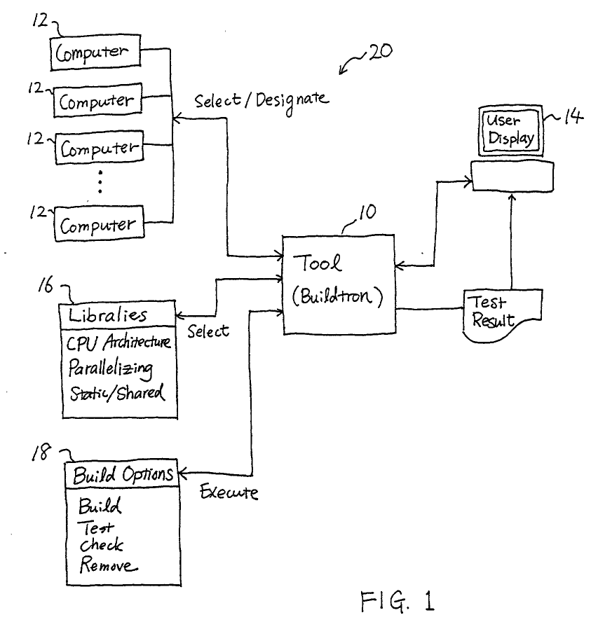

FIG. 1 schematically illustrates a tool 10 for building a selected group of computer programs on a selected computer in accordance with an embodiment of the present invention. The tool 10 is implemented in a computer system 20 for developing computer software, which includes a plurality of computers (build machines) 12 and a host computer 14. In the computer system 20, the build machines 12 and host computer 14 are networked so that they may communicate with one another. The host computer 14 serves as a user interface through which a software developer uses build machines 12 in the computer system 20.

The computer system 20 is capable of building various types of computer programs. Each of the build machines 12 is associated with at least one environmental characteristic, such as the number of CPUs, CPU architecture, a bus width, a version and type of an operating system, and an average load factor of the computer. These environmental characteristics correspond to that of a target machine or the environment under which the target program is to be executed. A software developer can select one of the build machines 12 to build his/her desired computer programs.

For an illustrative purpose, the tool 10 and the computer system 20 are described with respect to libraries as an example of the groups of computer programs. In general, a library is a collection of programs or data files. In a software development environment, a library is a set of software routines which are linked into a program when it is compiled. A library may be statically linked (archived) or dynamically linked (shared) during the execution of the program. However, the present invention is not limited to building libraries but equally applicable to other computer programs and groups of computer programs the creation of which is dependent upon environmental characteristics of a target computer.

It should be noted that although a typical example of a group of computer programs may be a library, “a group of computer programs” can be at any level of computer software, since a computer program itself may be an executable, a routine, a module, a Fortran application, a complex application, or a user makefile application, as described above. Thus, a group of computer programs may be a computer program that includes a plurality of subprograms or modules, may be a subprogram that includes a plurality of modules or executables, or may be an application.

As shown in FIG. 1, the system 20 is capable of building various types of libraries 16. A type of library may depend upon a number of CPUs and CPU architecture for which the library is built, parallelizing (threading) method used by the computer, static (archived) or dynamic (shared) link type, a bus width, a type and version of the operating system, and the like. The system 20 typically has a “make” utility and may also be capable of offering various build options 18 to the software developer, such as “build” libraries, “test” and “check” libraries, and “remove” prior versions of programs if any. Results of such tests or execution of a build process may be sent to the user in a conventional manner.

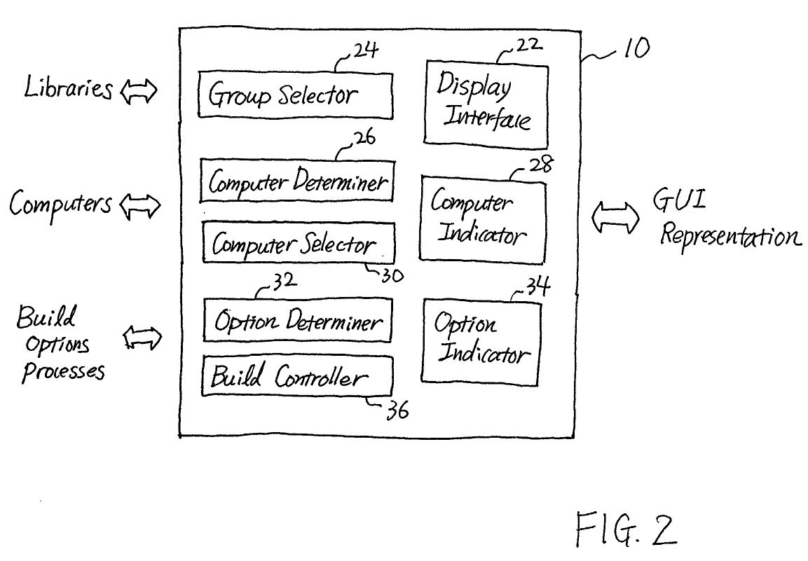

FIG. 2 schematically illustrates the tool 10 in more detail. As shown in FIG. 2, the tool 10 includes a display interface 22, a group selector 24, a computer determiner 26 a computer indicator 28, and a computer selector 30. The tool 10 may also include an option determiner 32 and an option indicator 34. The tool 10 may further include a build controller 36 for executing build processes.

The display interface 22 allows a user to make a selection of a build machine or build option from the display screen of the host computer 14. The display interface 22 is in a form of a graphical user interface (GUI) in one specific embodiment of the present invention.

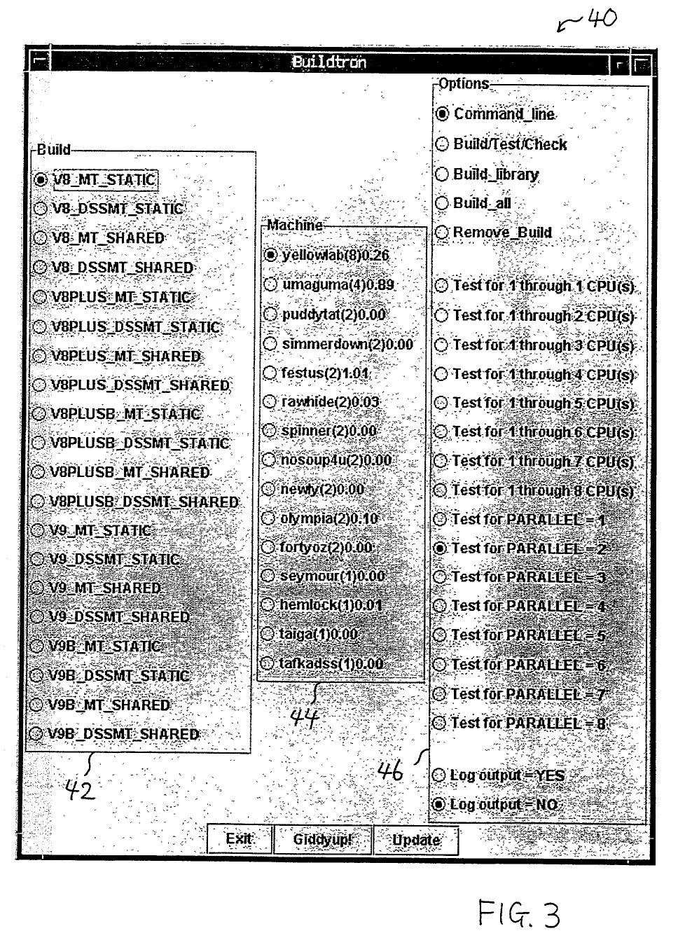

FIG. 3 illustrates an example of GUI representation 40 by the display interface 22 typically shown on the display screen of the host computer 14. As illustrated in FIG. 3, the GUI representation 40 includes a list of libraries 42 and a list of build machines 44. The list 42 shows various types of libraries that can be built using the system 20. In the list 42, each library is labeled with a set of specific environmental requirements in which the library is to be compiled and executed. Such a set may include one or more of environmental requirements such as a number of CPUs, CPU architecture for which the library is built, method of parallelizing/threading, link type of library (static or dynamic), a bus width, a type and version of the operating system, and the like. In the list 44, a plurality of build machines or computers are shown with at least one environmental characteristic, such as the number of CPUs and/or system load.

As shown in FIG. 3, the GUI representation 40 may also include a list of build options 46. The list 46 shows various build and test options available in the system 20. The build options on the list 46 may include building, testing, and/or checking a library, removing existing component computer programs and/or files from an location assigned to a selected library, and whether to and where to log a result of executing a selected build option. The user may also have an option to manually build a library through command line interface.

Referring back to FIG. 2, the group selector 24 selects a group of computer programs, i.e., a library, among the various types of libraries in accordance with the user's selection from the list 42.

The computer determiner 26 determines each computer 12 capable of building the selected library based on at least one environmental characteristic of the computer 12. For example, the computer determiner 26 retrieves information on environmental characteristics of computers 12, compares it with the environmental requirements of the selected library, and in response determines which computers 12 are capable of the build. The computer determiner 26 may make a query to the computers 12 to obtain the environmental characteristic, and/or maintain a file containing environmental characteristics of the computers 12. Such a file may be updated when configuration of one or more computers 12 is changed, one or more computers are added or removed from the system 20, or when requested by the user.

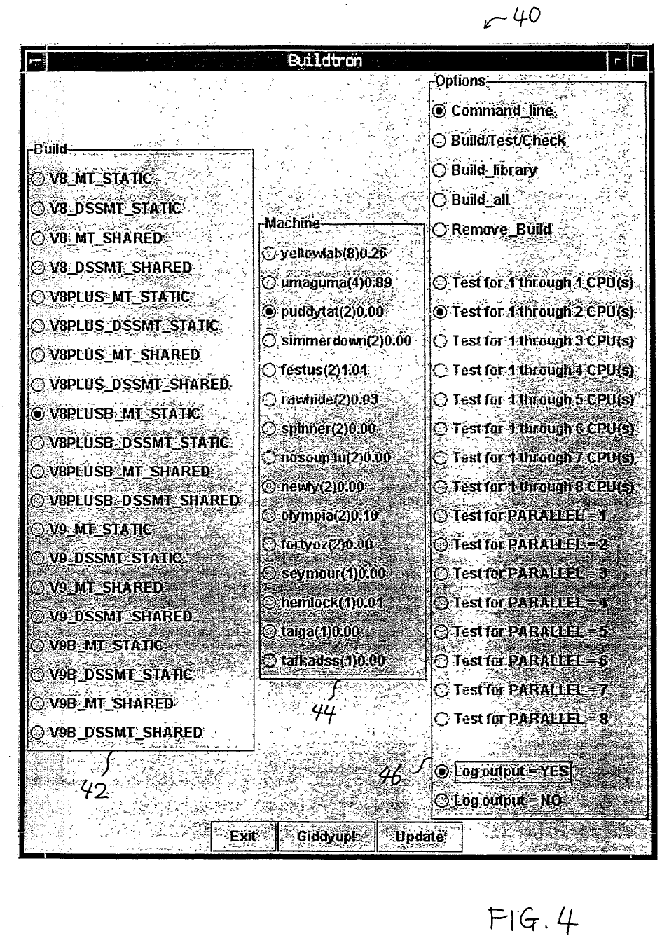

The computer indicator 28 indicates each capable computer 12 on the list 44, allowing the user to select a computer from among the indicated computers. The computer indicator 28 may, for example, highlight the capable computers on the list 44 or “gray out” those not capable as shown in FIG. 4. “Highlighting” may be the use of underlining, a bold type, a different color, or any other means to make the entries on the list 44 conspicuous or look different from others. The computer selector 30, in response to the user's selection of a capable computer from the list 44, implements that selection by designating the corresponding capable computer in the system.

According to an embodiment of the present invention, the tool 10 may include the option determniner 32 and the option indicator 34. The option determiner 32, in response to the user's selection of a capable computer, determines available build options for the selected computer. The option indicator 34 indicates the available build options on the list 46. Such indication may, for example, include highlighting the available options on the list 46, as shown in FIG. 4, where specific tests are indicated according the number of the CPUs.

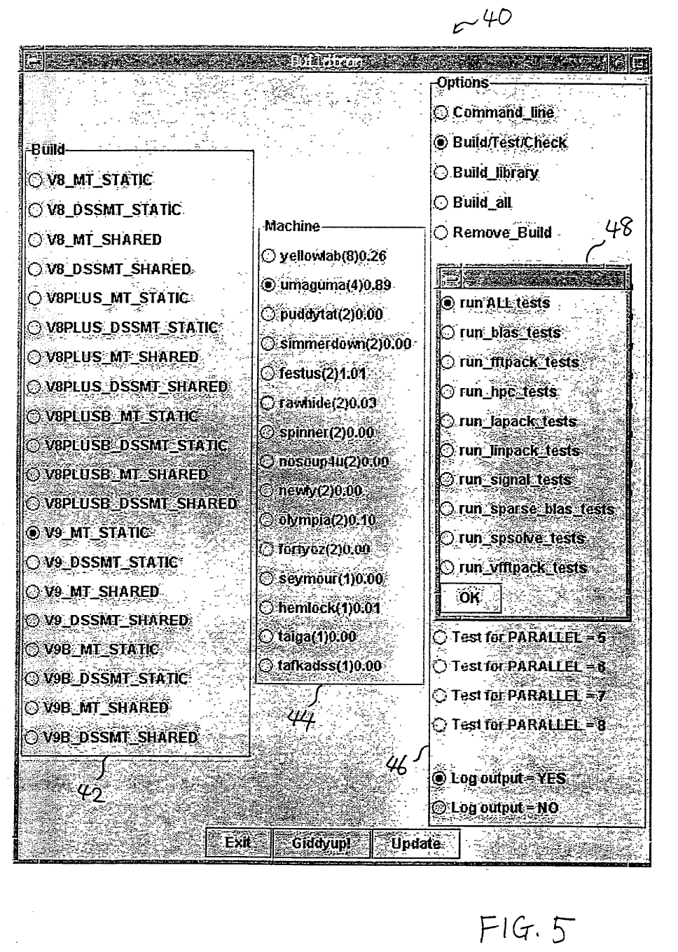

The option determiner 32 may further determine available processes for a selected build option, and the option indicator 34 may then display a list of the available processes on the display screen. For example, as shown in FIG. 5, when a user selects Build/Test/Check option, a list of various test processes 48 available for that option may be displayed.

The tool 10 may further include the build controller 36. The build controller 36 executes a build process for the selected library using the selected computer in accordance with the selected build option. The build controller 36 may output a result of executing the build process or test when such an option is selected.

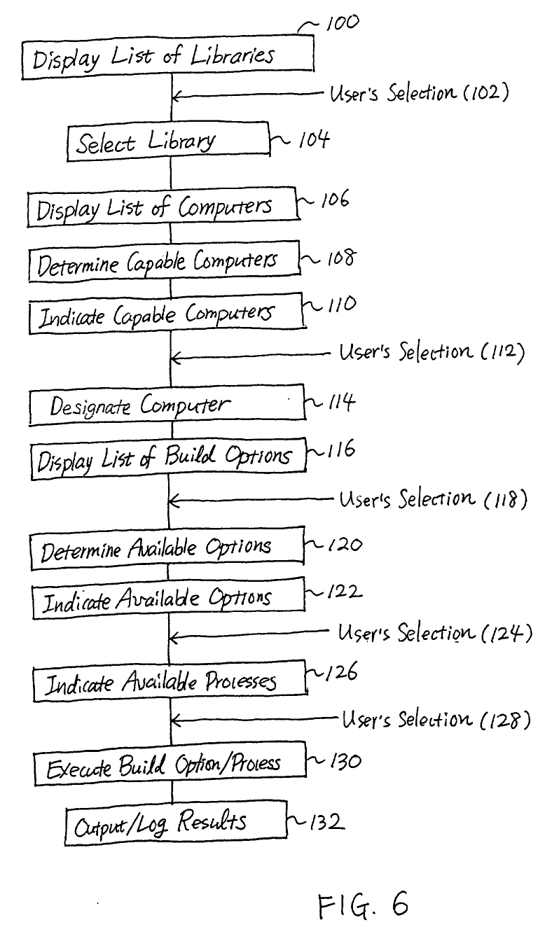

FIG. 6 schematically illustrates a method for building a group of computer programs selected from at least one group on a computer selected from a plurality of computers in accordance with an embodiment of the present invention. The method may be performed using a computer network system for developing computer software, such as the system 20 described above (FIG. 1), having a plurality of build machines (computers) 12 and a host computer 14 serving as a user interface. The computer network system is capable of building various types of computer programs and groups of computer programs, such as libraries.

As described above, each group of computer programs, such as a library, has a set of specific environmental requirements in which the group of computer programs is to be compiled and executed, and each computer (build machine) in the computer system is associated at least one environmental characteristic. In the following description, libraries are used as an example of groups of computer programs. However, the present invention is not limited to this example, and is equally applicable to the building of other computer programs which depend on environmental characteristics, as mentioned above.

As shown in FIG. 6, a list of a plurality of libraries (groups of computer programs) is displayed so as to allow a user to select a library to be built (100). For example, referring to FIG. 5, such a list 42 is displayed as a “Build” column, in which various types of libraries are listed with corresponding buttons. Each entry of the list 42 specifically refers to a particular library labeled with CPU architecture (V8, V8PLUS, V8PLUSB, V9, or V9B), ways of parallelizing/threading the code (DSSMT, or MT), and the type of the library (STATIC or SHARED). Here, the MT libraries are compiler parallelized, while the DSSMT libraries are hand threaded, and “STATIC” denotes an archived library, while “SHARED” denotes a dynamic library.

Referring back to FIG. 6, a user selects an library to be built from the list of libraries, for example, by clicking the corresponding button (102). In response to the user's selection, the corresponding library is selected (104).

A list of a plurality of computers is also displayed on the screen (106). For example, as shown in FIG. 3, such a list 44 is displayed as a “Machine” column, where computers used for building libraries are referenced. The first part of each entry represents the machine's name. The second part within parentheses represents the number of CPUs within the computer. The third part represents the “load average” of that machine. The load average is a way of determining how much work the CPUs are doing. For example, the first entry (with a marked button) of the list 44 refers to a computer named “yellowlab” having 8 CPUs, and the load average of the CPUs is 0.26.

Returning to FIG. 6, each computer capable of building the selected library is determined based on at least one environmental characteristic (108). The capable machines/computers are determined by checking machine statistics such as their CPU architectures and operating system versions, including a bus width (e.g., 32 bit or 64 bit).

Such statistics can be obtained by making a query or by checking system properties of each computer. The statistics can also be read from a file that contains the information. For example, the CPU architecture may be obtained by checking system configuration information, including type of the CPU(s), clock frequency, memory size, etc. Reading from the file is usually quicker than making a query to each computer. Information of the machine statistics can be updated by querying the network to check for new machines, or querying specified machines listed in a file.

The determined capable computers are indicated on the list of the computers in the display screen (110), so as to allow the user to select a capable computer from the list. That is, the capabilities and resources of the system are visualized to the user depending on the circumstances selected by the user. For example, as shown in FIG. 4, when a library “V8PLUSB_MT_STATIC” (with a marked button) is selected from the list 42, certain computers are no longer highlighted in the list 44. This clarifies to the user that only the highlighted machines are capable of building and testing the selected library. That is, since each library is dependent upon a particular CPU architecture, the only computers which have matching CPU architecture are highlighted.

When the user selects one of the highlighted computers from the list (112) (FIG. 6), the corresponding computer of the system is designated accordingly (114).

A list of user-selectable options such as build options is also displayed (116) so as to allow the user to select a build option according to the selected library and computer. For example, as shown in FIG. 3, such a list 46 is displayed as a column under the title “Options,” which specifies (a) options for how the user prefers to build the library, (b) how many CPUs the user would like to test with, and (c) whether or not the user prefers to have all output logged.

The “Command_line” button is used to bring up a terminal (window) which will then be set up to run the chosen library (from “Build” list) on the chosen computer (from “Machine” list). In this case, the rest of the build process is left up to the user.

The “Build/Test/Check” button is used to bring up a terminal which will then be set up to run the selected library on the selected computer. Under this option, the library chosen is built to completion, the tests are run to check the validity of the built library, and finally the results of the tests and build are checked and the output status is sent to the user.

The “Build_library” button is used to bring up a terminal which will then be set up to run the chosen library on the chosen computer. This option builds the chosen library without building or running tests.

The “Build_all” button is used to bring up a terminal which will then be set up to run the chosen library on the chosen computer. This option builds the chosen library and the tests required to test the library, without running the tests.

The “Remove_Build” button is used to bring up a terminal which will then be set up to run the chosen library on the chosen computer. This selection removes all of the files that were created from a previous build of the selected library. That is, the “Remove_build” option sets up the environmental variables etc. and removes the object files/executables/libraries in the predetermined location specified in the system.

The following options which begin with the words “Test for” allow the user to chose the degree of parallelism (threading) for which to test the library. For example, if the user chooses “Test for 1 through 2 CPU(s),” as shown in FIG. 4, the tests run against the library first with PARALLEL set to 1, then PARALLEL set to 2.

In addition, the following options may also be displayed. The “Log output” buttons allow the user the choice to have all of the building/testing output saved to a log file. Furthermore, as shown in the bottom of the screen, other buttons may be displayed to allow the user to issue other commands. The “Exit” button quits the GUI representation. The “Giddyup!” button starts the jobs selected. The “Update” button refreshes the “Machine” buttons, for example, the load averages are reprocessed, as these will change with the computer's workload.

Referring to FIG. 6, when an library and a capable computer are selected (118), only some of the build options are available to that selection. Thus, such available build options for the selected computer are determined (120), and the determined available build options are indicated on the list of build options (122).

For example, as shown in FIG. 4, when a library “V8PLUSB_MT_STATI” and a machine “puddytat(2)0.00” are selected, only some of the “Test for” buttons are highlighted in the list 46 according to the number of CPUs that the selected machine has available. The highlighting of entries/buttons within each list clarifies to the user the possible configurations available. This overrides the possibility of human error and grants the user the ability to build and test a library without knowing the configuration of each computer.

In addition, as shown in FIG. 6, in response to the user's selection (124), available build processes may be further determined for a selected build option and displayed as a list of the available processes (126). For example, as shown in FIG. 5, the functionality available when the user selects the “Build/Test/Check” button may be displayed. When the “Build/Test/Check” option is selected, a window (a list of test options) 48 appears that allows the user to run all library tests, or select a desired set of tests. In this example shown in FIG. 5, the user has selected to “run ALL tests” as the corresponding button is marked.

Referring to FIG. 6, in response to the user's selection (128) of build option and/or process, the selected build option and/or process is executed for the selected library using the selected computer (130). As described above, such execution may be started by clicking a corresponding button (such as “Giddyup!” in FIG. 5) on the user display screen. In addition, when such an option is selected, the result of the execution may be output or saved in a file (132).

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for building a group of computer programs selected from at least one group of computer programs on a selected computer of a plurality of computers, said plurality of computers being networked to a computer system having a user interface, said method comprising:
displaying a list of said at least one group of computer programs so as to allow a user to select a group to be built, each of said at least one group of computer programs having a set of specific environmental requirements in which said group of computer programs is to be compiled and executed;
displaying a list of said plurality of computers, each of said plurality of computers having at least one environmental characteristic;
receiving a user's selection of a group of computer programs from said list of said at least one group of computer programs;
determining each computer capable of building the selected group of computer programs based on said at least one environmental characteristic;
indicating each said capable computer on said list of the computers; and
designating a capable computer in response to the user's selection of a computer from said list of the computers.

2. A method according to claim 1, further comprising:
displaying a list of user-selectable options.

3. A method according to claim 2, further comprising:
determining available build options for the selected computer; and
indicating said available build options on said list of user-selectable options.

4. A method according to claim 2, further comprising:
executing, in response to a user-selectable option being selected, a build process for the selected group of computer programs using the selected computer.

5. A method according to claim 4, further comprising:
outputting a result of said executing the build process.

6. A method according to claim 2, wherein said user-selectable options include at least one of:
building a group of computer programs;
testing a group of computer programs;
checking a group of computer programs;
removing existing computer programs and files from a specific location assigned to a selected group; and
logging a result of executing a selected build option.

7. A method according to claim 2, further comprising:
determining available processes for a user-selectable option being selected; and
displaying a list of said available processes.

8. A method according to claim 1, wherein said determining each computer includes:
obtaining said at least one environmental characteristic of each computer; and
comparing said at least one environmental characteristic with said specific environmental requirements of the selected group of computer programs.

9. A method according to claim 8, further comprising:
maintaining a file containing environmental characteristics of the computers; and
reading said at least one environmental characteristic of each computer from said file.

10. A method according to claim 9, wherein said maintaining includes updating said environmental characteristics of the computers contained in said file.

11. A method according to claim 8, wherein said at least one environmental characteristic is obtained by making a query to said computers.

12. A method according to claim 1, wherein said at least one environmental characteristic of the computer includes at least one of a number of CPUs within the computer, CPU architecture, a bus width, a version and type of an operating system, and average load of the computer.

13. A method according to claim 1, wherein in said indicating includes highlighting each said capable computer on said list of the computers.

14. A method according to claim 1, wherein said set of specific environmental requirements includes at least one of a number of CPUs, CPU architecture, a bus width, and a type and version of an operating system.

15. A method according to claim 1, wherein said at least one group of computer programs is at least one library.

16. A method according to claim 15, wherein said set of specific environmental requirements includes at least one of a number of CPUs, CPU architecture, a bus width, a type and version of an operating system, a method of compiling, and a link type of a library.

17. A method according to claim 16, wherein said displaying a list of said at least one group of computer programs includes showing at least one of said specific environmental requirements for each library.

18. In a software developing environment, a tool for building a group of computer programs selected from at least one group of computer programs on a selected computer of a plurality of computers, said plurality of computers being networked to a computer system having a user interface, said tool comprising:
a display interface allowing a user to make a selection, including:
a list of said at least one group of computer programs, each said group of computer programs having a set of specific environmental requirements in which said group of computer programs is to be compiled and executed; and
a list of said plurality of computers, each of said plurality of computers having at least one environmental characteristic;
a group selector receiving and implementing a user's selection of a group of programs from said list of said at least one group of computer programs;
a computer determiner to determine each computer capable of building the selected group of computer programs based on said at least one environmental characteristic;
a computer indicator for indicating each said capable computer on said list of the computers; and
a computer selector, responsive to the user's selection of a computer on said list of the computer, to designate a corresponding capable computer from among said plurality of computers in the system.

19. A tool according to claim 18, wherein said display interface further includes a list of user-selectable options.

20. A tool according to claim 19, further comprising:
an option indicator, responsive to the user's selection of a computer, to determine available build options for the selected computer and to indicate said available build options on said list of user-selectable options.

21. A tool according to claim 20, further comprising:
a build controller, responsive to the user's selection of a build option, to execute a build process for the selected group of programs using the selected computer in accordance with the selected build option.

22. A tool according to claim 21, wherein said build controller outputs a result executing the build process.

23. A tool according to claim 19, wherein said user-selectable options include at least one of:
building a group of computer programs;
testing a group of computer programs;
checking a group of computer programs;
removing existing computer programs and files from a specific location assigned to a selected group; and
logging a result of executing a selected build option.

24. A tool according to claim 19, wherein said option indicator further determines available processes for a user-selectable option being selected, and displays a list of said available processes on said display interface.

25. A tool according to claim 18, wherein said computer determiner includes:
a properties determiner for obtaining said at least one environmental characteristic of the computers; and
a comparer for comparing said at least one environmental characteristic with the environmental requirements of the selected group of computer programs.

26. A tool according to claim 18, wherein said computer determiner further includes:
a file for storing the environmental characteristics of the computers.

27. A tool according to claim 26, wherein said computer determiner further includes:
a file maintainer for updating said environmental characteristics of the computers contained in said file.

28. A tool according to claim 25, wherein said properties determiner makes a query to the computers to obtain said at least one environmental characteristic.

29. A tool according to claim 18, wherein said at least one environmental characteristic of the computer includes at least one of a number of CPUs within the computer, CPU architecture, a bus width, a version and type of an operating system, and average load of the computer.

30. A tool according to claim 18, wherein said computer indicator highlights each said capable computer on said list of the computers.

31. A tool according to claim 18, wherein said set of specific environmental requirements includes at least one of a number of CPUs required, CPU architecture, a bus width, and a type and version of an operating system.

32. A tool according to claim 18, wherein said groups of computer programs are libraries.

33. A tool according to claim 32, wherein said set of specific environmental requirements includes at least one of a number of CPUs, CPU architecture, a bus width, a type and version of an operating system, a method of compiling, and a link type of a library.

34. A tool according to claim 33, wherein said list of said at least one group of computer programs includes at least one of said specific environmental requirements associated with each library.

35. An apparatus for building a group of computer programs selected from at least one group of computer programs on a selected computer of a plurality of computers, said plurality of computers being networked to a computer system having a user interface, said apparatus comprising:
means for displaying a list of said at least one group of computer programs so as to allow a user to select a group to be built, each said group of computer programs having a set of specific environmental requirements in which said group of computer programs is to be compiled and executed;
means for displaying a list of said plurality of computers, each of said plurality of computers having at least one environmental characteristic;
means for receiving a user's selection of a group of computer programs from said list of at least one group of computer programs;
means for determining each computer capable of building the selected group of programs based on said at least one environmental characteristic;
means for indicating each said capable computer on said list of the computers; and
means for designating a capable computer in response to the user's selection of a computer from said list of computers.

36. An apparatus according to claim 35, further comprising:
means for displaying a list of user-selectable options.

37. An apparatus according to claim 36, further comprising:
means for determining available build options for the selected computer; and
means for indicating said available build options on said list of user-selectable options.

38. An apparatus according to claim 36, further comprising:
means for executing, in response to a user-selectable option being selected, a build process for the selected group of computer programs using the selected computer.

39. An apparatus according to claim 38, further comprising:
means for outputting a result of said executing the build process.

40. An apparatus according to claim 36, wherein said user-selectable options include at least one of:
building a group of computer programs;
testing a group of computer programs;
checking a group of computer programs;
removing existing computer programs and files from a specific location assigned to a selected group; and
logging a result of executing a selected build option.

41. An apparatus according to claim 36, further comprising:
means for determining available processes for a user-selectable option being selected; and
means for displaying a list of said available processes.

42. An apparatus according to claim 35, wherein said means for determining each computer includes:
means for obtaining said at least one environmental characteristic of each computer; and
means for comparing said at least one environmental characteristic with said specific environmental requirements of the selected group of computer programs.

43. An apparatus according to claim 42, further comprising:
means for maintaining a file containing environmental characteristics of the computers; and
means for reading said at least one environmental characteristic of each computer from said file.

44. An apparatus according to claim 43, said means for maintaining includes means for updating said environmental characteristics of the computers contained in said file.

45. An apparatus according to claim 42, wherein said means for obtaining includes means for making a query to said computers to obtain said at least one environmental characteristic.

46. An apparatus according to claim 35, wherein said at least one environmental characteristic of the computer includes at least one of a number of CPUs within the computer, CPU architecture, a bus width, a version and type of an operating system, and average load of the computer.

47. An apparatus according to claim 35, wherein in said means for indicating includes means for highlighting each said capable computer on said list of the computers.

48. An apparatus according to claim 35, wherein said set of specific environmental requirements includes at least one of a number of CPUs, CPU architecture, a bus width, and a type and version of an operating system.

49. An apparatus according to claim 35, wherein said at least one group of computer programs are at least one library.

50. An apparatus according to claim 49, wherein said set of specific environmental requirements includes at least one of a number of CPUs, CPU architecture, a bus width, a type and version of an operating system, An apparatus of compiling, and a link type of a library.

51. An apparatus according to claim 50, wherein said means for displaying a list of said at least one group of computer programs includes means for showing at least one of said specific environmental requirements for each library.

52. A program storage device readable by a computer, tangibly embodying a program of instructions executable by the computer to perform a method for building a group of computer programs selected from at least one group of computer programs on a selected computer of a plurality of computers networked to a computer system having a user interface, said method comprising:
displaying a list of said at least one group of computer programs so as to allow a user to select a group to be built, each of said at least one group of computer programs having a set of specific environmental requirements in which said group of computer programs is to be compiled and executed;
displaying a list of said plurality of computers, each of said plurality of computers having at least one environmental characteristic;
receiving a user's selection of a group of computer programs from said at least one group;
determining each computer capable of building the selected group of programs based on said at least one environmental characteristic;
indicating each said capable computer on said list of the computers; and
designating a capable computer in response to the user's selection of a computer from said list of computers.
